(19) United States
(12) Patent Application Publication
(10) Pub. No.: US 2023/0167729 A1
(43) Pub. Date: Jun. 1, 2023

(54) Separator Trailer

(71) Applicant: Robert Niland, The Woodlands, TX (US)

(72) Inventor: Robert Niland, The Woodlands, TX (US)

(21) Appl. No.: 18/071,385

(22) Filed: Nov. 29, 2022

Related U.S. Application Data
(60) Provisional application No. 63/284,558, filed on Nov. 30, 2021.

(51) Int. Cl. E21B 43/34; B01D 17/02

(52) U.S. Cl. CPC E21B 43/34; B01D 17/0211; B01D 17/0214; B01D 2221/04

(57) ABSTRACT

An improved method for separating solids from liquid in a slurry comprising solids and a liquid (e.g., an aqueous solution) is disclosed. Combining the separator, the gun barrel and a weir tank together are plumbed there between for a simplified and easy system on wheels for the petrochemical industry. The disclosure allows for easy transportation and use thereof for smaller jobs and more frequent use.

### CROSS REFERENCE

The present non-provisional patent application claims priority in its entirety to the provisional patent application 63284558 titled ‘The Separator Trailer,’ filed by Robert Niland Nov. 30, 2021.

### BACKGROUND

In the petrochemical industry a frac tank is a large capacity steel tank that can store liquids or solids like petroleum products, chemicals, manure, saline water, and propellants. Frac tanks have been useful in all kinds of applications, and there are different variations of tanks. There are open top weir tanks that are steel frack tanks designed to help control the flow of liquids up to one hundred gallons per minute (GPM). Their primary function is to segregate residual fluids, oils, and contaminants using weirs or baffles inside the tank. Weir tanks separate and store different liquid types, mixed with waste and other contaminants from runoff water to diesel fuel, oils, chemicals, and other waste products. Also used are gun barrel separators which are atmospheric vessels that producers use to separate oil, water, and gas coming from a tank battery. Tank batteries, are a system consisting of produced water, natural gas, and crude oil storage tanks, connected by pipelines, used to store these products. All products produced from the various well sites then travel via pipelines to a centrally-located tank battery location. However, the battery tanks, and separators are affixed and there aren't easier ways of transporting this process for smaller jobs. There have been no products available as original equipment or as an aftermarket to address this problem.

An improved method and system for recovering oil and other component layers from wastewater from a well with a need for high efficiency, reduced cost, smaller footprint, easily interfaced to the well sites and locations, and mobility is needed. There have been no products available as original equipment or as an aftermarket to address this problem either.

There exists a need for an improved system addressing these problems and offers significant cost savings by enhanced/improved recovery of oil, reduction of disposal fees, reduction of transportation expenses, re-use of water, and elimination. of underground pumping/disposal of produced water that is not being met by any known or disclosed device or system of present.

### SUMMARY OF THE INVENTION

The separator simplifies the process of using battery tanks, and separators and providing transportation of this process for smaller jobs. An improved method and system for recovering oil and other component layers from wastewater from a well with a need for high efficiency, reduced cost, smaller footprint, easily interfaced to the well sites and locations, and mobility is disclosed.

### BRIEF DESCRIPTION OF THE DRAWINGS

FIG. 1 is a right side elevational view of the separator trailer apparatus in accordance with an embodiment of the present disclosure.

FIG. 2 is a detail view of the separator trailer in accordance with an embodiment of the present disclosure.

FIG. 3 is a detail view of the water leg component of the separator trailer in accordance with an embodiment of the present disclosure.

FIG. 4 is a detail view of the gun barrel component of the separator trailer in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

The term ‘frack’ and ‘fracking’ are used herein to define hydraulic fracturing as a well stimulation technique involving the fracturing of bedrock by a pressurized liquid.

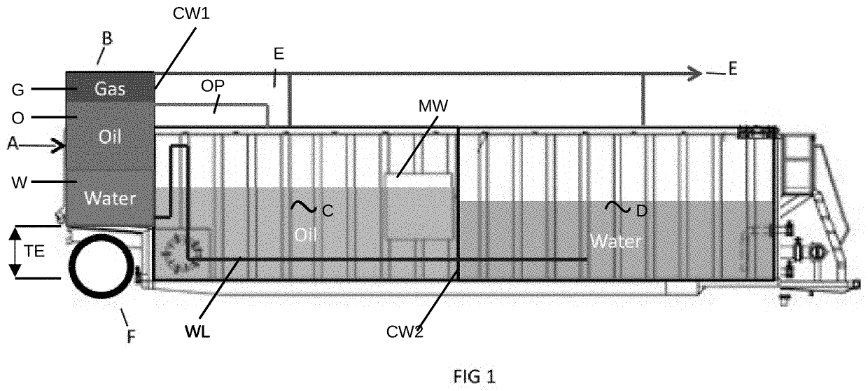

FIG. 1 is a right side elevational view of the separator trailer showing:

production from well referenced as A, gun barrel separator (optional) referenced as B, tank 1 referenced as C, tank 2 referenced as D, gas vent referenced as E, and axle for transport (optional) referenced as F, gun barrel gas tank G, gun barrel Oil tank O, gun barrel Water tank W, and water leg WL in accordance with an embodiment of the present disclosure. The man way MW enables human access for cleaning and inspection. The total elevation TE difference between the gun barrel and the holding tanks provide a gravity pressure on the gun barrel fluids.

Ingenious and practical, the separator is uniquely designed to combine the separator, the gun barrel and said two oil tanks, one pressurized and the other ambient and a water tank all into a common walls single inclusive tank with plumbing included. Water is heavier than oil so it can be drained from the ambient tank, with the separator accelerating the separation. The gun barrel is designed to be an optional attachment to the weir tank and is equipped with an axle and wheels for transportation. This is helpful for times when just the modular tank is needed. This expanded designed tank and separator could also be done retrofitting storage containers.

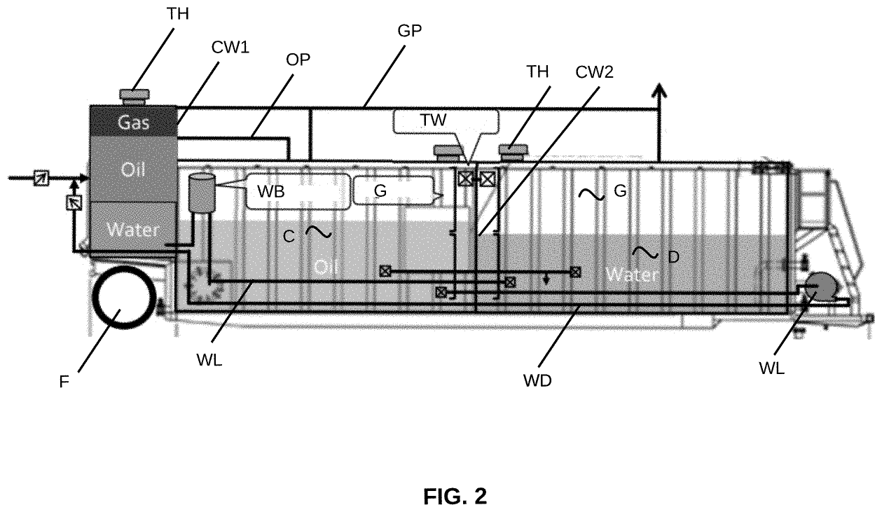

FIG. 2 is a detail view of the separator trailer in accordance with an embodiment of the present disclosure. Limitations similar in the present FIG. 2 to limitations in FIG. 1 are referenced with same reference characters. Additionally, the present FIG. 2 includes a weir box WB, gas plumbing GP, common wall one CW1, common wall two CW2, oil plumbing OP, thief hatches TH, water line WL, water plumbing WP, production line A, gas boot G, water drain WD, and pump P. The top wall TW is a ceiling and a roof for the disclosure.

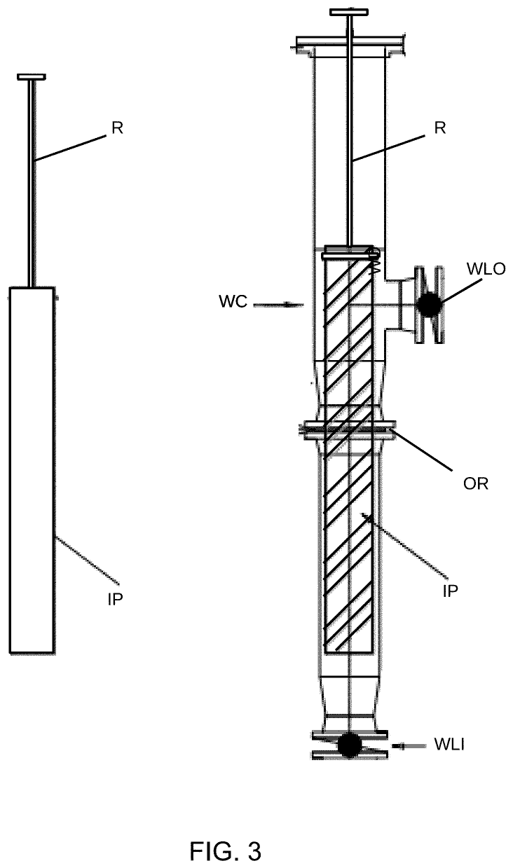

FIG. 3 is a detail view of the water leg component of the separator trailer in accordance with am embodiment of the present disclosure. The water from the gun barrel B passes through the water leg. It consists of a larger pipe OP, a narrower pipe IP running inside the larger one OP, and a wider compartment WC at the top. Water flows from the drain up through the narrower pipe IP to the larger space WC at the top. Additional gas separates at this point. A small line runs from the compartment to the top of the tank, equalizing the pressure between the two.

Water flows over the top of the smaller pipe IP, and then down into the outside leg OP and then to a dump valve and tank. The water leg output WLO and the water leg input SWI are in communication with the gun barrel water tank portion.

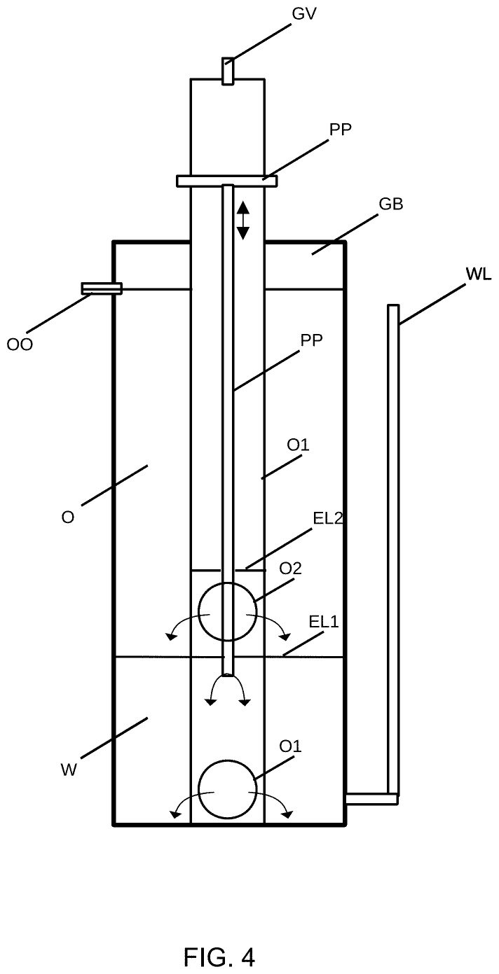

FIG. 4 is a view of the gun barrel component of the separator trailer in accordance with an embodiment of the present disclosure. Limitations include the gas boot G, the production pipe PP, the water leg WL, lower orifice O1, upper orifice O2, oil output OO, the oil portion OP of the gun barrel O, the gas vent GV, production input PI and the water portion WP. The production pipe length is adjustable up and down inside the separation tube ST denoted by the double headed arrow. The separation tube ST is also known as a downcomer pipe and extends from the roof of the gun barrel to within feet of the bottom of the gun barrel. Oil and water exit the downcomer pipe respectively at the upper orifice O2 and at the lower orifice O1 into the gunbarrel B. The emulsion line EL1 is where oil separates from water in the downcomer pipe ST. The emulsion line EL2 is where gas separates from oil in the downcomer pipe ST. Gunbarrel sizing is determined by a 3 to 2 ratio of the height to the width of the gunbarrel. The water leg WL controls the depth of the liquids in the gunbarrel. The height of the gas portion in the downcomer pipe is determined by the gas pressure in the gas boot PI and also influences the emulsion levels EL1 and EL2 and the amount of fluid 130 exiting the lower and the upper orifices O1 and O2. The penetration of the production pipe into the downcomer pipe ST also determines the area of the churning or emulsifying between EL1 and EL2 and thus the fluid volumes leaving O1 and O2 into the gunbarrel B.

Both water in a water disposal line and clean oil in an oil flow line are both held to a height of several feet above dump valves. These valves are usually controlled by a weight on a lever arm, which can be adjustable. Adjustments are generally unusual. The valves don't control the height of the water in the tanks, only what's held in the out flowing lines. The amount of liquid held in the tanks is controlled by height of the outlet lines on the tank.

Gun barrels operate with the emulsion entering an inlet inside or beside the tank. Gas breaks out at the top in the large compartment, and the liquid drops below where it enters the gun barrel and is then spread across the bottom. The clean oil flows out through the line near a top of the tank and is piped to the stock tanks.

Some attributes of the disclosed Modular GunBarrel Tank include portability—the disclosed system incorporates three tanks in one portable skid design. Oil Tank—the disclosure is capable of one full oil haul truck payload of 180 bbls. Water Tank—provides one full water vac truck or water haul truck payload of 180 bbls. GunBarrel Tank B—provides a water and oil separation vessel. Adjustable Oil/Water Interface—operator tailors the operational parameters of the constituent fluids per the disclosure. The adjustment range is based on the total elevation of the gunbarrel tank above the Water and Oil tanks. Recycle capability—includes a small gas powered recycle pump P to recycle the water and oil tanks or to transfer to another storage tank (pump limitations would apply for transfer applications). Pressure Relief—Tank Thief Hatches TH are included on all three compartments to prevent vessel over pressure and vessel collapse due to internal vacuum pressure. Independent Tank Thieving/Gauging—Tank Thief Hatches allow accurate tank level gauging for volumetrics and/or sales volumes. Independent Tank Cleanouts—manways MW are included in each tank to allow human access for cleaning and inspection. Tank Pressure Equalization—interconnected tank vapor space allows the disclosed tanks to maintain pressure equalization and proper gravity feed operation.

Additional attributes of the disclosure include Independent Tank Access—permanent fixed or quick installation steps and handrail lead to the top or side of the vessels for human access. Independent Front Loading is enabled via front of skid vessel load in/out nozzles. Optional Inlet Nozzle Location—inlet to the disclosed gunbarrel vessel from the front or from the rear of the skid for optimal operational positioning and connection. Vessel Level Gauges—independent vessel (Water/Oil/Gunbarrel) sight glass level gauges are included for operational ease and transparency. Tapered Vessel Floor—the vessel floors slope to the center of the disclosed vessel for improved volume delivery over flat floor vessels. Vessel Separation Walls—provide structural separation by walls separating the independent vessel compartments. Vapor Space Vent Riser—extendable vapor space vent risers are included for safe evacuation of vapors. Optional Vapor Recovery Unit Connection Port—includes a connection nozzle for a temporary Vapor Recovery Unit for vapor collection and compression to a sales gas pipeline or pressure vessel. An Influent Rotational Diffuser—a diffuser on the influent (inlet) of the gunbarrel initiates rotational flow for improved fluid and phase separation. Inlet/Outlet Oppositional Placement—gunbarrel influent and effluent are located at opposite corners of the gunbarrel vessel for maximum residence time. Independent Exterior Vessel Drains—each vessel has an exterior drain for additional operational connection possibilities. A vessel Equalizer/Overflow Port—where ports between each vessel allow spillage into a lower volume vessel. Exterior Overflow Nozzles—each vessel includes spillover nozzles to allow overflow capture or direction to reserve pit or containment.

Corrugated walls per the disclosure add structural integrity and additional roof support for personnel and roof access. The disclosed rectangular design maximizes storage volumes over traditional cylindrical tank shapes. Drain valves on the axle end provide proper draining for delivery and transport.

Embodiments of the present disclosure include retrofitting existing tank batteries to realize the portable tank crude oil and water separator. A tank battery includes any combination of oil collection tanks, brine collection tanks and associated equipment within a containment dike. In other words, a tank battery means the group of equipment used to separate, treat, store and transfer crude condensate, natural gas and produced water prior to the tank battery outlet for transportation, typically a meter or valve.

Embodiments of the separator trailer include the gun barrel and said two oil tanks, one pressurized and the other ambient and a water tank having common walls for a single inclusive tank with plumbing included. The disclosure is distinguished from fracking with wheels and chassis. Also, the gun barrel height is taller than a fracking trailer tank. Water is heavier than oil so it can be drained from the ambient tank though the separator and accelerate the separation.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A crude oil and water separator battery comprising:
a portable tank comprising three horizontal partitions and two inside common walls, wherein one partition is a gun barrel, a second partition is an oil tank and a third partition is a water tank;
a water leg attached to a bottom portion of the gun barrel and extending to the water tank and comprising a concentric portion of pipe separated from a weir box by an o-ring;
an oil plumbing proximal a top of the gun barrel and extending to the oil tank.

2. The crude oil and water separator battery of claim 1, wherein a height of the weir nipple of the water leg is adjustable via a rod.

3. The crude oil and water separator of claim 1, further comprising a gas boot proximal a top of the gun barrel.

4. The crude oil and water separator of claim 1, further comprising an elevator for a bottom of the gun barrel configured at a height above a bottom of the water tank.

5. The crude oil and water separator of claim 1, further comprising a ratio of a height of the gun barrel to a diameter of the gun barrel equal to or greater than one.

6. The crude oil and water separator of claim 1, further comprising a ratio of a height of the gun barrel to a diameter of the gun barrel of 3 parts to 2 parts.

7. The crude oil and water separator of claim 1, further comprising an outer pipe extending through a center of the gun barrel and a downcomer pipe extending a vertical length inside the outer pipe.

8. The crude oil and water separator of claim 1, further comprising a plurality of sight glasses embedded in a respective outer wall of the gun barrel, the oil tank and the water tank.

9. The crude oil and water separator of claim 1, further comprising a gas equalization line from a top side of the gun barrel to a gas tank.

10. The crude oil and water separator of claim 1, further comprising a plurality of gun barrel horizontal partitions effecting a plurality of gun barrel tanks.

11. The crude oil and water separator of claim 1, further comprising a plurality of wheels on the portable tank.

12. The crude oil and water separator of claim 1, wherein a maximum height of the portable tank

13. The crude oil and water separator of claim 1, wherein the oil tank is adjacent the gun barrel and the water tank is adjacent the oil tank.

14. The crude oil and water separator of claim 1, wherein the water tank is adjacent the gun barrel and the oil tank is adjacent the water tank.

15. The crude oil and water separator of claim 1, wherein the water leg is internal to the water tank.

16. The crude oil and water separator of claim 1, wherein the gun barrel shares a common wall with the water tank and shares a common wall with the oil tank.

17. The crude oil and water separator of claim 1, further comprising a wash plumbing from a bottom of the gun barrel to the water tank.

18. The crude oil and water separator of claim 1, wherein the oil plumbing in internal to the tank.

19. The crude oil and water separator of claim 1, further comprising an equalizing plumbing connecting a top of the gun barrel to a top of the oil tank to a top of the water tank.

20. The crude oil and water separator of claim 1, wherein a bottom of the oil tank and a bottom of the water tank are lower than a bottom of the gun barrel.
